(19) United States
(12) Patent Application Publication
(10) Pub. No.: US 2006/0097513 A1
(43) Pub. Date: May 11, 2006

(54) Identification Label

(76) Inventor: Mason A. Caldwell, Colorado Springs, CO (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/160,626

(22) Filed: Jun. 30, 2005

Related U.S. Application Data
(60) Provisional application No. 60/521,775, filed on Jul. 1, 2004.

(51) Int. Cl. B42D 15/00

(52) U.S. Cl. 283/72

(57) ABSTRACT

The present invention is a security label for property. The label's adhesive is impregnated with a highly concentrated UV reflective material. The label is also embossed with a security feature on one layer. The combination of the embossing and the UV reflective adhesive leaves a patterned footprint on an article if the label is removed. The label also incorporates excising of material in an indicia pattern, thereby leaving an additional shadow in the UV footprint. Standard marking methods may also be used in conjunction with the present label invention.

### FIELD OF INVENTION

The present invention relates to the field of identification labels and more particularly relates to labels with adhesive infused with ultraviolet (“UV”) reflective material such that a UV shadow and pattern inherent in the label are left on an object to which the label was adhered and then removed.

### BACKGROUND OF THE INVENTION

Adhesive labels are known in the prior art as a tool for use in identifying anything from files to inventory. Particular labels feature an inherent security device to indicate tampering with the label. Other labels utilize the presence of a UV reflective material to leave a footprint of said UV reflective material on an object to which a label has been adhered and removed. However, prior art labels with UV impregnation leave only a weak footprint. Indicia left on the object is limited to UV “holes” from where indicia were cut into a label, thus never exposing the object to the UV material in those areas.

While such labels accomplish their individual objectives, they do not disclose a label that masks its UV qualities while simultaneously providing a hidden and patterned UV footprint to an adhered object. In this respect, the label according to the present invention departs substantially from the usual designs in the prior art. In doing so, this invention provides a UV impregnated label capable of leaving, not only a footprint detailing disclosed indicia, but also hidden indicia while simultaneously masking the UV properties.

### SUMMARY OF THE INVENTION

In view of the foregoing disadvantages inherent in the known types of identifying labels, this invention provides an improved UV impregnated label. As such, the present invention's general purpose is to provide a new and improved label that will leave an identifiable UV footprint on an object after the label is removed while simultaneously concealing identifying indicia, other information and the very fact the label is UV impregnated.

To accomplish this invention, the label comprises at least 5 layers, with a releasable backing comprising two layers. The label has an ink receptive top coating, allowing for manual marking of the label, on top of standard label stock. Underneath the label stock is a layer embossed with hidden information. This information is revealed when the label is removed. Underneath the embossed layer, there is a pigment lacquer, giving the label an opaque coloring. Underneath this lacquer, is an adhesive layer that has been infused with heavy concentrations of UV reflective material. The backing layer is a simple liner with a silicone based release coating on one side. This release coating abuts the adhesive layer when the labels are stored before use.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top plan view of a label according to the present invention.

FIG. 2 is an enlarged side elevation of the label according to the present invention.

FIG. 3 is a sectional view of the label of the present invention, divided along line 3 in FIG. 2, at the boundary between the stock and embossed layers.

FIG. 4 is the label of FIG. 2 affixed to a surface.

FIG. 5 is the label of FIG. 4 removed from the surface.

FIG. 6 is the surface shown in FIG. 5, with the remaining label removed.

### DETAILED DESCRIPTION OF THE PREFERRED EMBODIMENT

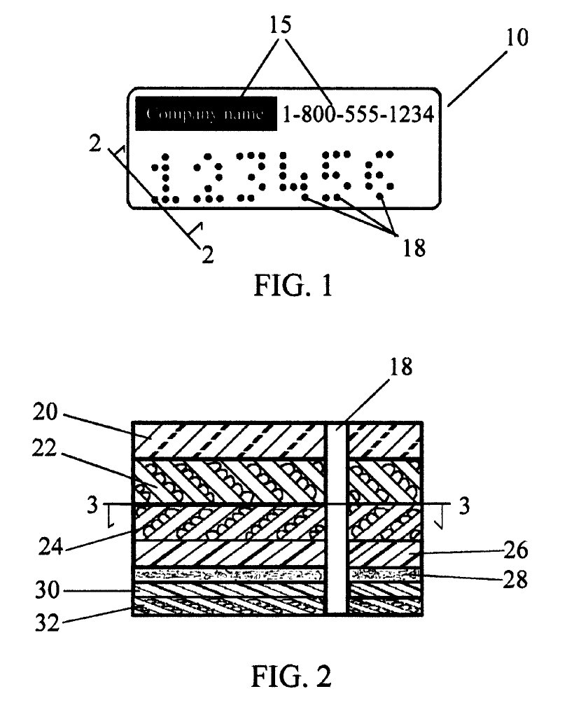

With reference now to the drawings, the preferred embodiment of the label is herein described. With particular reference to FIGS. 1 and 2 the label is comprised of a plurality of layers and features. The surface layer 20 of the label 10 is a markable surface and is ideally durable, transparent and waterproof. On this surface layer 20, a user may inscribe or print any manner of indicia 15. Certain generic indicia may also be printed on stock layer 22, which is covered by surface layer 20.

Surface layer 20 is directly adjacent and adhered to label stock layer 22. Label stock layer 22 provides a base layer for the entire label and the material utilized in creating the label stock layer may be one of any number of materials readily available in the art. The current preferred materials would include paper, polyester and polypropylene, though other materials, natural and synthetic, could be used as well any later developed materials that would could serve as a base.

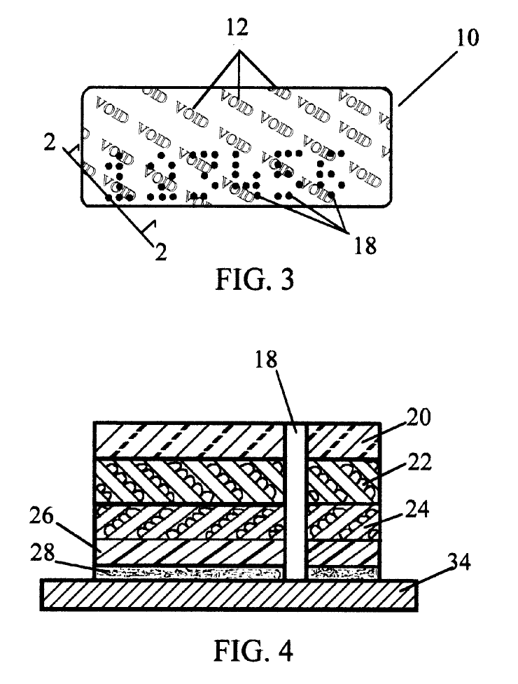

Directly beneath and adhered to label stock layer 22 is embossed layer 24. Embossing is utilized on this layer to structurally weaken it in particular areas so as to create a pattern 12, shown in FIG. 3. This pattern is also significant as there are inherent variances in the structural integrity of the label as a result of the embossed pattern. When the label is removed, FIG. 5, areas of the label within each embossed pattern is left behind, as the label lacks the integrity to have these areas removed. These variances also alter the ability of ultraviolet (“UV”) material to impregnate the surface to which the label is adhered and thereby create a pattern in the UV footprint after the label is removed from a surface.

The final two label layers are a pigment lacquer layer 26, providing opacity for the label, hiding its UV properties, and following methods and means known in the art, and an adhesive layer 28. Adhesive layer is impregnated with a significant amount of UV reflective material. The balance of reflective material and adhesive must be such that there is enough material to leave a footprint while also allowing the label to adhere to a surface. Most label makers have a proprietary mix that is not disclosed, however, the transference properties are roughly equal for different mixes. Ideally, the concentration of UV reflective material will be 12-20% of the adhesive mix and will be applied at a thickness of approximately 1.1 mils, significantly more than the normal label adhesive layer though a range of thickness may be utilized depending on the actual adhesive mix. The significant amount of UV reflective material, combined with the increased adhesive thickness, creates a strong UV footprint on a surface in a lesser amount of time than prior art labels and provides an opportunity for variances in pressure from the label to be displayed in that footprint as a residual pattern. These variances are caused by the embossed layer. Two backing layers, a backing base layer 32 and a releasable layer 30, are also provided according to the prior art.

Indicia may also be encoded into the label by punching out areas of the label to create holes 18. Holes 18 may be in a significant pattern so as to provide further security, as areas not covered by a label will not be impregnated with UV reflective material, shown in FIG. 4, thereby providing two encoded patterns within the footprint. The holes 18 may be provided by any known means, including but not limited to punching, die cutting, and laser cutting.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A security label capable of leaving a footprint that is reflective of ultraviolet light, said label comprising:
A markable layer;
A label stock layer;
An embossed layer having a definite embossed pattern;
An opaque lacquer layer;
An adhesive layer heavily impregnated with an ultraviolet reflective material, comprising between 12% and 20% of the adhesive layer;
Wherein, pressure differentials caused by the embossed layer alter the rate in which ultraviolet reflective material is left on an affixed surface, leaving the embossed pattern in an ultraviolet footprint on the surface after the label is removed.

2. The security label of claim 1, further comprising at least one aperture being created through the label before affixation on a surface, wherein no ultraviolet reflective material will be transferred.

3. A method for marking durable goods, the method comprising:
creating a label with both an internal embossed security layer and an adhesive layer containing a significant amount of material reflective of ultraviolet light;
affixing the label to a surface of an object to be marked;
allowing transfer of ultraviolet reflective material from the label to the object in a manner that emulates the embossed pattern;
wherein when the label is removed, an ultraviolet reflective footprint is left on the surface of the object, said footprint also incorporating a pattern after the manner of the embossed pattern.

4. The method of claim 3, further comprising the step of forming at least one aperture through the label before affixing said label to the surface, said at least one aperture being additional identifying indicia.

5. The method of claim 4, the label having an opaque, non-reflective layer covering the ultraviolet reflective adhesive in a manner to conceal the adhesive's ultraviolet reflective property.

6. The method of claim 5, wherein the ultraviolet reflective adhesive layer is a thickness between 0.9 and 1.5 mils.

7. The method of claim 5, the adhesive layer having a concentration of 12-20% UV reflective material.

8. The method of claim 4, wherein the ultraviolet reflective adhesive layer is a thickness between 0.9 and 1.5 mils.

9. The method of claim 4, the adhesive layer having a concentration of 12-20% UV reflective material.

10. The method of claim 3, wherein the ultraviolet reflective adhesive layer is a thickness between 0.9 and 1.5 mils.

11. The method of claim 3, the adhesive layer having a concentration of 12-20% UV reflective material.
